(19) United States
(12) Patent Application Publication
(10) Pub. No.: US 2025/0193569 A1
(43) Pub. Date: Jun. 12, 2025

(54) WEARABLE ELECTRONIC DEVICE COMPRISING MICROPHONE MODULE

(71) Applicant: Samsung Electronics Co., Ltd., Suwon-si (KR)

(72) Inventors: Seunga LEE, Suwon-si (KR); Lockhee KANG, Suwon-si (KR); Yongwook PARK, Suwon-si (KR); Sangwoo YU, Suwon-si (KR); Yongbum JEUNG, Suwon-si (KR)

(21) Appl. No.: 19/056,254

(22) Filed: Feb. 18, 2025

Related U.S. Application Data
(63) Continuation of application No. PCT/KR2023/012353, filed on Aug. 21, 2023.

(30) Foreign Application Priority Data
Aug. 22, 2022 (KR) 10-2022-0105106
Aug. 23, 2022 (KR) 10-2022-0105559

(51) Int. Cl. H04R 1/08; H04R 1/22; H04R 1/28

(52) U.S. Cl. CPC H04R 1/083; H04R 1/222; H04R 1/2876; H04R 2410/05; H04R 2410/07; H04R 2420/07; H04R 2460/01

(57) ABSTRACT

A wearable electronic device is provided. The wearable electronic device includes a housing including a first surface facing an outside of the wearable electronic device, a second surface opposite to the first surface, and a microphone hole formed between the first surface and the second surface, a support disposed on the second surface and including a microphone chamber at least partially facing the microphone hole, an antenna structure positioned on the second surface, a connecting member disposed on the second surface and including a first connection area electrically connected to the antenna structure and a second connection area extending from the first connection region and disposed on the support, and microphone disposed on the second surface and configured to obtain an external sound of the wearable electronic device through the microphone hole and the microphone chamber.

### CROSS-REFERENCE TO RELATED APPLICATION(S)

This application is a continuation application, claiming priority under 35 U.S.C. § 365(c), of an International application No. PCT/KR2023/012353, filed on Aug. 21, 2023, which is based on and claims the benefit of a Korean patent application number 10-2022-0105106, filed on Aug. 22, 2022, in the Korean Intellectual Property Office, and of a Korean patent application number 10-2022-0105559, filed on Aug. 23, 2022, in the Korean Intellectual Property Office, the disclosure of each of which is incorporated by reference herein in its entirety.

### BACKGROUND

### 1. Field

The disclosure relates to a wearable electronic device including a microphone module.

### 2. Description of Related Art

The term “electronic device” may mean a device performing a function according to its equipped program, such as a home appliance, an electronic scheduler, a portable multimedia player, a mobile communication terminal, a tablet personal computer (PC), a video/sound device, a desktop PC or laptop computer, a navigation for automobile, etc. For example, the electronic devices may output stored information as voices or images. As electronic devices are highly integrated, and high-speed, high-volume wireless communication becomes commonplace, an electronic device, such as a mobile communication terminal, is recently being equipped with various functions. For example, an electronic device comes with various integrated functions, including an entertainment function, such as playing video games, a multimedia function, such as replaying music/videos, a communication and security function for mobile banking, and a scheduling or e-wallet function. These electronic devices have been downsized to be conveniently carried by users. As electronic, communication technology develops, these electronic devices are becoming smaller and lighter enough to be worn on the body without discomfort.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device including a microphone module.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a housing including a first surface facing an outside of the wearable electronic device, a second surface opposite to the first surface, and a microphone hole formed between the first surface and the second surface, a support disposed on the second surface and including a microphone chamber at least partially facing the microphone hole, an antenna structure positioned on the second surface, a connecting member disposed on the second surface and including a first connection area electrically connected to the antenna structure and a second connection area extending from the first connection area and disposed on the support, and a microphone disposed on the second surface and configured to obtain an external sound of the wearable electronic device through the microphone hole and the microphone chamber.

In accordance with another aspect of the disclosure, an electronic device is provided. The electronic device includes a housing including a wearing part, a microphone hole including a first microphone hole and a second microphone hole formed in the wearing part, an antenna structure positioned on an inner surface of the wearing part, a touch pad positioned on the inner surface of the wearing part, a support positioned on the inner surface of the wearing part and including a first support and a second support, the first support including a first microphone chamber and the second support including a second microphone chamber, a connecting member including a first connecting member connected to the antenna structure and at least partially disposed on the first support and a second connecting member connected to the touch pad and at least partially disposed on the second support, and a microphone including a first microphone configured to obtain sound passing through the first microphone hole and the first microphone chamber and a second microphone configured to obtain sound passing through the second microphone hole and the second microphone chamber.

In accordance with another aspect of the disclosure, an operation method of an electronic device is provided. The operation method includes determining a target frequency band causing wind noise commonly in a plurality of microphones, determining a microphone having a highest gain value among the plurality of microphones in the target frequency band, and providing an inverse gain value of the highest gain value to the plurality of microphones.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an audio module according to an embodiment of the disclosure;

FIG. 3 is a perspective view illustrating an electronic device according to an embodiment of the disclosure;

FIG. 4A is a rear perspective view illustrating an electronic device including a connecting member and a microphone hole according to an embodiment of the disclosure;

FIG. 4B is a front perspective view illustrating an electronic device according to an embodiment of the disclosure;

FIG. 5 is a rear perspective view illustrating an electronic device including a microphone hole and a support according to an embodiment of the disclosure;

FIG. 6 is a graph illustrating wind noise changed based on a microphone chamber of a support according to an embodiment of the disclosure;

FIG. 7 is a graph illustrating pink noise changed based on a microphone chamber of a support according to an embodiment of the disclosure; and

FIG. 8 is a flowchart illustrating operations of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

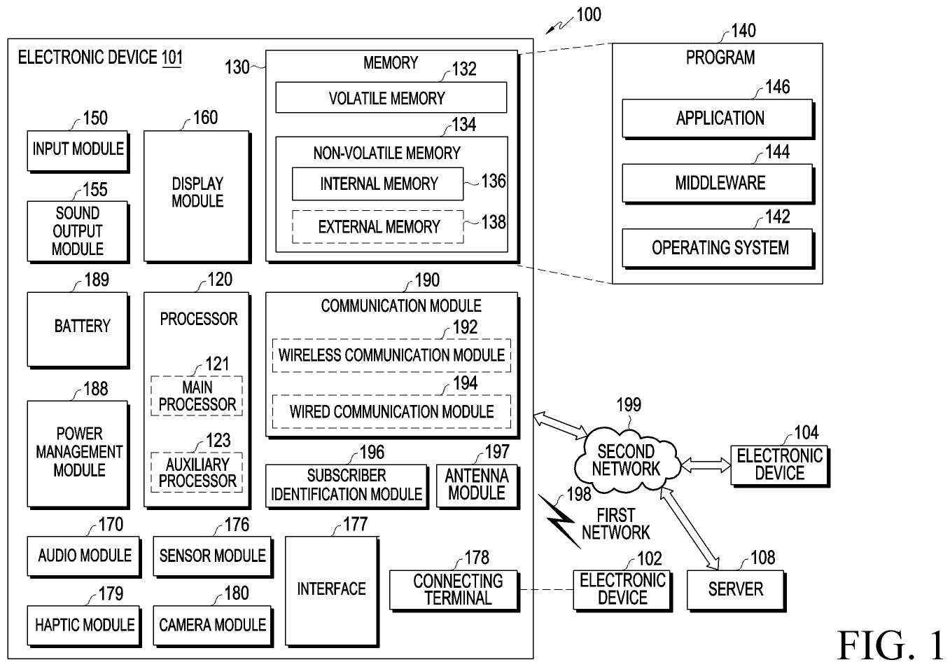

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include one or more of an internal memory 136 and an external memory 138.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module may include an antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 and 104 and the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

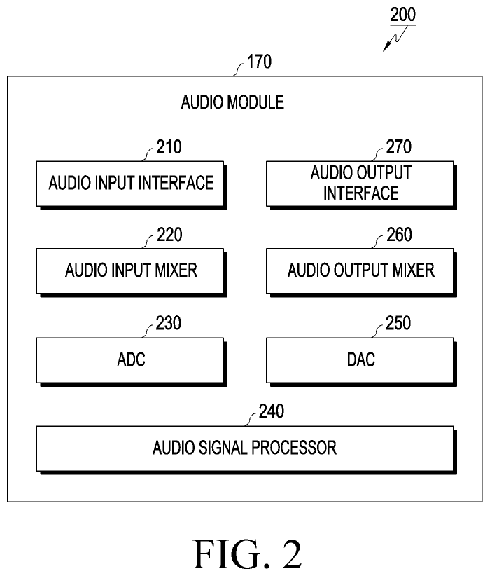

FIG. 2 is a block diagram illustrating an audio module according to an embodiment of the disclosure.

Referring to FIG. 2, block diagram 200 illustrates that an audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

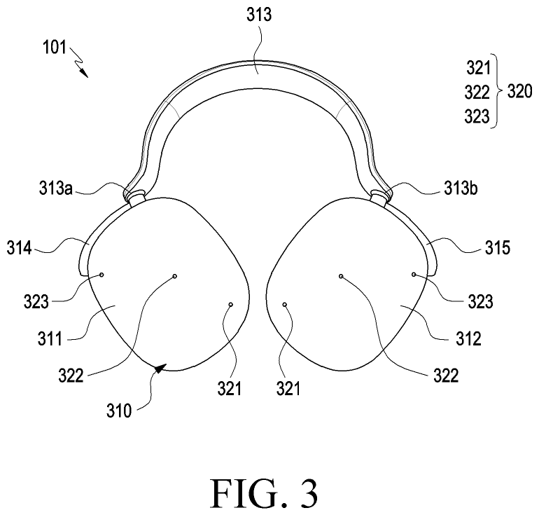

FIG. 3 is a perspective view illustrating an electronic device according to an embodiment of the disclosure.

Referring to FIG. 3, an electronic device 101 may include a housing 310 for accommodating components of the electronic device 101. For example, sound components (e.g., the audio module 170 of FIG. 2) and electronic components (e.g., the processor 120, the power management module 188, the battery 189, or the wireless communication module 192 of FIG. 1) may be disposed inside the housing 310. The configuration of the electronic device 101 of FIG. 3 may be identical in whole or part to the configuration of the electronic device 101 of FIG. 1.

According to an embodiment, the electronic device 101 may be a wearable electronic device. For example, the electronic device 101 may be an electronic device that may be worn on a part of the body, e.g., an ear or a head. According to an embodiment, the electronic device 101 may be an over ear headphone that covers the ears.

According to an embodiment, the electronic device 101 may be electrically connected to an external electronic device (e.g., the electronic device 102 of FIG. 1). For example, the electronic device 101 may function as an audio output interface (or the sound output module 155 of FIG. 1) that outputs a sound signal received from the external electronic device 102 to the outside.

According to an embodiment, the electronic device 101 may communicate with the external electronic device 102 or may be controlled by the external electronic device 102. The electronic device 101 may be an interactive electronic device paired with an external electronic device 102 such as a smart phone through a communication scheme such as Bluetooth™ to convert data received from the external electronic device 102 to output a sound or to receive the user's voice and transmit the user's voice to the external electronic device 102.

According to an embodiment, the electronic device 101 may be wirelessly connected to the external electronic device 102. For example, the electronic device 101 may communicate with the external electronic device 102 via a network (e.g., a short-range wireless communication network or a long-range wireless communication network). The network is not limited thereto, but may include a mobile or cellular communication network, a local area network (LAN) (e.g., Bluetooth™ communication), a wireless local area network (WLAN), a wide area network (WAN), the Internet, or a small area network (SAN). According to an embodiment, the electronic device 101 may be wiredly connected to the external electronic device 102 using a cable (not shown).

According to an embodiment, the electronic device 101 may not communicate with the external electronic device 102. In this case, the electronic device 101 may be implemented not be controlled through the external electronic device 102, but to receive a signal corresponding to a sound obtained from the outside and output a sound signal to the outside according to the operation (or control) of the components included in the electronic device 101. For example, the electronic device 101 may be a stand-alone electronic device that plays music or a video by itself without communicating with the external electronic device 102 and outputs a sound or receives and processes the user's voice.

In the disclosure, the structure of the electronic device 101 may be changed. For example, the electronic device 101 is mainly described as a headphone that covers the ears, but the disclosure is not limited thereto. Although not illustrated in the drawings, the electronic device 101 may be an in-ear earset, an in-ear headset, or a hearing aid. For example, the electronic device 101 may be a kernel-type in-ear earset for being mounting in the external auditory meatus from the auricle to the eardrum, or an open-type earset for being mounted on the auricle.

According to an embodiment, the housing 310 may include a plurality of components. For example, the housing 310 may include wearing parts 311 and 312 that form at least a portion of the exterior of the electronic device 101 and provide a space for accommodating components of the electronic device 101. The wearing parts 311 and 312 may include a first wearing part 311 and a second wearing part 312 spaced apart from each other.

According to an embodiment, with the user wearing the electronic device 101, at least a portion of the first wearing part 311 may cover at least a portion of the user's body (e.g., the right ear), and at least a portion of the second wearing part 312 may cover at least a portion of the user's body (e.g., the left ear).

According to an embodiment, the housing 310 may include a band part 313 connecting the first wearing part 311 and the second wearing part 312. With the user wearing the electronic device 101, the band part 313 may face at least a portion (e.g., head) of the user's body. According to an embodiment, the first wearing part 311 may be electrically connected to the second wearing part 312 using a flexible printed circuit board or a cable positioned in the band part 313. According to an embodiment, the shape of the first wearing part 311 may be substantially symmetrical to the shape of the second wearing part 312.

According to an embodiment, the first wearing part 311 and/or the second wearing part 312 may be rotatably connected to the band part 313. For example, the housing 310 may include a first rotation part 314 rotatably connected to a first end 313a of the band part 313 and a second rotation part 315 rotatably connected to a second end 313b of the band part 313. The first rotation part 314 may be coupled to the first wearing part 311. The first wearing part 311 may rotate with respect to the band part 313 together with the first rotation part 314. The second rotation part 315 may be coupled to the second wearing part 312. The second wearing part 312 may rotate with respect to the band part 313 together with the second rotation part 315.

According to an embodiment, the housing 310 may include a microphone hole 320. According to an embodiment, the microphone hole 320 may be interpreted as a through hole formed in the wearing parts 311 and 312.

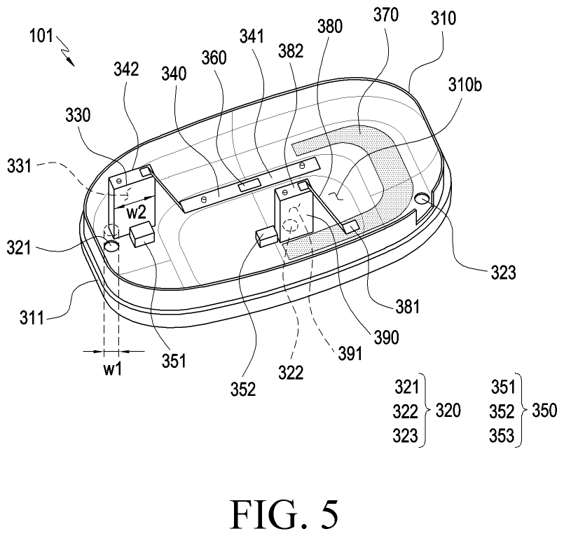

According to an embodiment, the external sound of the electronic device 101 may be transferred to a microphone module (e.g., microphone module 350 of FIG. 5) positioned inside the electronic device 101 after passing through the microphone hole 320. According to an embodiment, the microphone hole 320 may include a plurality of microphone holes 321, 322, and 323. For example, the microphone hole 320 may include a first microphone hole 321, a second microphone hole 322 spaced apart from the first microphone hole 321, and/or a third microphone hole 323 spaced apart from the second microphone hole 322.

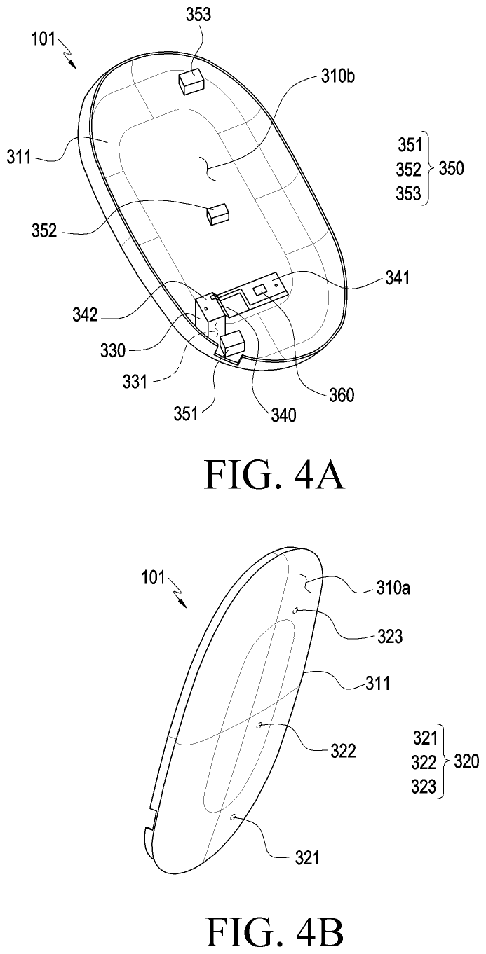

FIG. 4A is a rear perspective view illustrating an electronic device including a connecting member and a microphone hole according to an embodiment of the disclosure. FIG. 4B is a front perspective view illustrating an electronic device according to an embodiment of the disclosure. FIG. 5 is a rear perspective view illustrating an electronic device including a microphone hole and a support according to an embodiment of the disclosure.

Referring to FIGS. 4A, 4B, and/or 5, an electronic device 101 may include a housing 310, a microphone hole 320, a support 330, a connecting member 340, and/or a microphone module 350. The configuration of the housing 310 and the microphone hole 320 of FIGS. 4A, 4B, and/or 5 may be identical in whole or part to the configuration of the housing 310 and the microphone hole 320 of FIG. 3.

According to an embodiment, the housing 310 may include a first surface 310a facing the outside of the electronic device 101 and a second surface 310b opposite to the first surface 310a. According to an embodiment, at least one component may be disposed on the second surface 310b. For example, the connecting member 340, the microphone module 350, an antenna structure 360, and/or a touch pad 370 may be disposed on the second surface 310b. The first surface 310a may be referred to as an outer surface of the housing 310, and the second surface 310b may be referred to as an inner surface of the housing 310. The first surface 310a and the second surface 310b may be surfaces of a wearing part (e.g., the first wearing part 311 and/or the second wearing part 312 of FIG. 3) of the housing 310.

According to an embodiment, the microphone hole 320 may be formed between the first surface 310a and the second surface 310b. For example, the microphone hole 320 may be a through hole penetrating the first surface 310a and the second surface 310b. At least a portion of the external sound or vibration of the electronic device 101 may be transferred to the microphone module 350 through the microphone hole 320.

According to an embodiment, the electronic device 101 may include at least one microphone hole 320. For example, the microphone hole 320 may include the first microphone hole 321, the second microphone hole 322, and the third microphone hole 323 spaced apart from each other. In the disclosure, a structure in which three microphone holes 321, 322, and 323 are positioned in one wearing part (e.g., the first wearing part 311) is illustrated, but the structure of the electronic device 101 is not limited thereto. For example, the electronic device 101 may have two or less microphone holes or more than four microphone holes in one wearing part (e.g., the first wearing part 311 or the second wearing part 312).

According to an embodiment, the support 330 may support a component of the electronic device 101. For example, the support 330 may support at least a portion (e.g., second connection area 342) of the connecting member 340. As the support 330 supports the connecting member 340, at least a portion of the connecting member 340 may be connected to a component (e.g., a main circuit board) positioned inside the electronic device 101. By the support 300, shaking of the connecting member 340 may be reduced, and durability of the electronic device 101 may be enhanced. The support 330 may be referred to as a support member or a support area.

According to an embodiment, the support 330 may be disposed on the second surface 310b of the housing 310. According to an embodiment, the support 330 may be integrated with the wearing parts 311 and 312 of the housing 310. For example, the support 330 may be a portion of the wearing parts 311 and 312 extending on the second surface 310b. The support 330 may be an injection-molded material formed together with the wearing parts 311 and 312 of the housing 310. According to an embodiment, the support 330 may be a separate structure disposed on the second surface 310b and coupled to the wearing parts 311 and 312.

According to an embodiment, the support 330 may include a microphone chamber 331. The microphone chamber 331 may be an empty space formed inside the support 330. At least a portion of the microphone chamber 331 may face at least a portion of the microphone hole 320. The microphone chamber 331 may be connected to the microphone hole 320. For example, the microphone chamber 331 may be interpreted as a structure spatially connected to one (e.g., the first microphone hole 321) of the plurality of microphone holes 321, 322, and 323. The sound or vibration transferred to the microphone hole 320 may be transferred to the microphone chamber 331. The external sound or vibration of the electronic device 101 may be transferred to a first microphone 351 through the microphone hole 320 and the microphone chamber 331. According to an embodiment, the microphone chamber 331 may be referred to as a first microphone chamber.

According to an embodiment, the microphone chamber 331 may reduce wind noise. For example, at least a portion of the wind flowing into the electronic device 101 may be transferred to the microphone module 350 through the microphone chamber 331. As at least a portion of the wind passes through the microphone chamber 331, turbulence for vibrating the microphone module 350 may be reduced. According to an embodiment, the second width w2 of the microphone chamber 331 may be larger than the first width w1 of the microphone hole 320. The volume and/or cross-sectional area of the microphone chamber 331 may be larger than the volume and/or cross-sectional area of one microphone hole (e.g., the first microphone hole 321).

According to an embodiment, the electronic device 101 may include a sound absorbing member (not shown) positioned in the microphone chamber 331. According to an embodiment, the sound absorbing member (not shown) may reduce a designated noise among sounds transferred to the microphone module 350. For example, the sound absorbing member (not shown) may reduce the sound corresponding to the wind noise while maintaining the sound corresponding to the pink noise as substantially the same. The sound absorbing member may include an open cell polyurethane foam.

According to an embodiment, the connecting member 340 may connect a component disposed on the second surface 310b of the housing 310 to a circuit board (not shown) positioned in the inner space of the housing 310. The circuit board may be a main circuit board that accommodates a processor (e.g., the processor 120 of FIG. 1) and/or an audio module (e.g., the audio module 170 of FIG. 2) of the electronic device 101. For example, the connecting member 340 may include a first connection area 341 positioned on the second surface 310b and a second connection area 342 extending from the first connection area 341. At least a portion of the second connection area 342 may be disposed on the support 330. According to an embodiment, the distance between the second connection area 342 and the second surface 310b of the housing 310 may be longer than the distance between the first connection area 341 and the first surface 310a of the housing 310. The second connection area 342 may include a connector to be connected to the circuit board positioned in the inner space of the housing 310. According to an embodiment, the connecting member 340 may be a flexible printed circuit board or a cable.

According to an embodiment, the connecting member 340 may be electrically connected to the antenna structure 360. The antenna structure 360 may be identical in whole or part to the configuration of the antenna module 197 of FIG. 1. According to an embodiment, the antenna structure 360 may be positioned on the connecting member 340 disposed on the second surface 310b. According to an embodiment, the antenna structure 360 may be a conductive antenna pattern. According to an embodiment, the connecting member 340 may be referred to as an antenna flexible printed circuit board or a first flexible printed circuit board.

According to an embodiment, the microphone module 350 may obtain an external sound of the electronic device 101. The electronic device 101 may receive an audio sound corresponding to the sound obtained from the outside of the electronic device 101 using the microphone module 350. For example, the microphone module 350 may obtain a sound passing through the microphone hole 320 and the microphone chamber 331. The configuration of the microphone module 350 may be identical in whole or part to the configuration of the audio module 170 of FIG. 2. For example, the microphone module 350 may include the audio input interface 210, the audio input mixer 220, the ADC 230, and/or the audio signal processor 240 of FIG. 2.

According to an embodiment, the microphone module 350 may include a plurality of microphones. For example, the microphone module 350 may include the first microphone 351 adjacent to the first microphone hole 321, a second microphone 352 adjacent to the second microphone hole 322, and/or a third microphone 353 adjacent to the third microphone hole 323. According to an embodiment, the first microphone 351 may be referred to as a microphone module closest to the user's mouth among the plurality of microphones 351, 352, and 353 while the user wears the electronic device 101. According to an embodiment, the first microphone hole 321 may be referred to as a microphone hole closest to the user's mouth among the plurality of microphone holes 321, 322, and 323 while the user wears the electronic device 101.

In the disclosure, a structure in which two microphones 351 and 352 are positioned in one wearing part (e.g., the first wearing part 311) is illustrated, but the structure of the electronic device 101 is not limited thereto. For example, the electronic device 101 may further include a third microphone adjacent to the third microphone hole 323. The number of microphone modules 350 of the electronic device 101 may be the same as the number of microphone holes 320.

According to an embodiment, the microphone module 350 may be disposed in the housing 310. The microphone module 350 may be spatially connected to the microphone chamber 331 formed in the support 330. According to an embodiment, the microphone module 350 may be disposed on a circuit board (not shown) disposed on the second surface 310b of the housing 310.

According to an embodiment, the microphone module 350 may be positioned adjacent to the support 330. The microphone module 350 may receive a sound transferred from the microphone chamber 331. The microphone module 350 may include at least one hole (not shown) facing at least a portion of the microphone chamber 331.

According to an embodiment, the processor (e.g., the processor 120 of FIG. 1) and/or the audio module (e.g., the audio module 170 of FIG. 2) may perform an active noise cancelling (ANC) function using the microphone module 350. The active noise canceling function may be a function for reducing noise by obtaining a sound-related wave using the microphone module 350, inverting the phase of the obtained wave, and outputting the phase-inverted wave through the speaker. Noise generated outside the electronic device 101 may be reduced by destructive interference using the active noise canceling function. According to an embodiment, wind noise may be reduced by the microphone chamber 331, and performance of the active noise canceling function may be enhanced.

According to an embodiment, the electronic device 101 may include a touch pad 370. According to an embodiment, the touch pad 370 may detect the user's input. For example, when the user's body (e.g., finger) approaches (e.g., contacts) the first surface 310a of the housing 310, the touch pad 370 may detect a change in electrical capacity generated by the user's body. The processor 120 may perform a predetermined function based on the user input detected by the touch pad 370. According to an embodiment, the touch pad 370 may be disposed on the second surface 310b of the housing 310.

According to an embodiment, the electronic device 101 may include a touch pad connecting member 380 connected to the touch pad 370. The touch pad connecting member 380 may electrically connect the touch pad 370 to the main circuit board positioned in the housing 310. The touch pad connecting member 380 may be a flexible printed circuit board and/or a cable. According to an embodiment, the touch pad connecting member 380 may be referred to as a second connecting member.

According to an embodiment, the touch pad connecting member 380 may be disposed on a second support 390. For example, the touch pad connecting member 380 may include a third connection area 390a positioned on the second surface 310b and a fourth connection area 390b extending from the third connection area 390a. At least a portion of the fourth connection area 390b may be disposed on the second support 390. The fourth connection area 390b may include a connector to be connected to the circuit board positioned in the inner space of the housing 310. The second support 390 may be referred to as an auxiliary support 390.

The second support 390 may include a second microphone chamber 391. The second microphone chamber 391 may be an empty space formed inside the second support 390. At least a portion of the second microphone chamber 391 may face at least a portion of the microphone hole 320. For example, the second microphone chamber 391 may be interpreted as a structure spatially connected to one (e.g., the second microphone hole 322) of the plurality of microphone holes 321, 322, and 323. The sound or vibration transferred to the microphone hole 320 may be transferred to the second microphone chamber 391. The external sound or vibration of the electronic device 101 may be transferred to the second microphone 352 through the second microphone hole 322 and the second microphone chamber 391. According to an embodiment, the second microphone chamber 391 may be referred to as an auxiliary microphone chamber.

According to an embodiment, the second support 390 may be positioned adjacent to one microphone hole 320. For example, the second support 390 may be positioned adjacent to the second microphone hole 322. However, the position of the second support 390 is selective. For example, according to an embodiment, the second support 390 may be positioned adjacent to the third microphone hole 323. The sound passing through the third microphone hole 323 may be transferred to the third microphone through the second microphone chamber 391 of the second support 390.

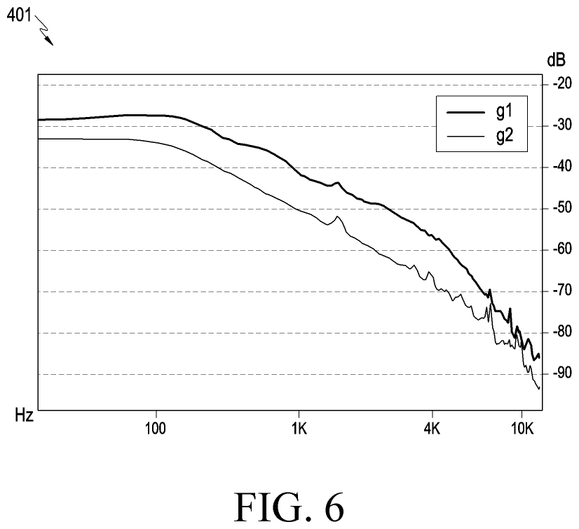

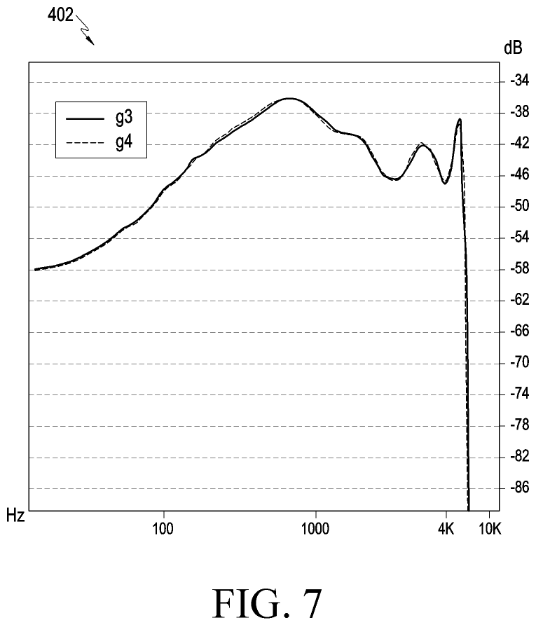

FIG. 6 is a graph illustrating wind noise changed based on a microphone chamber of a support according to an embodiment of the disclosure. FIG. 7 is a graph illustrating pink noise changed based on a microphone chamber of a support according to an embodiment of the disclosure. FIGS. 6 and 7 may show frequency-response graphs. For example, the vertical axis of FIGS. 6 and 7 may represent the magnitude dB of the response, and the horizontal axis may represent the frequency hertz (Hz). FIG. 6 and/or FIG. 7 are graphs for comparing the structure of the electronic device 101 of FIGS. 3, 4A, 4B, and 5 with the structure of the electronic device not including the microphone chamber.

Referring to FIG. 6, graph 401 illustrates that wind noise g2 of the electronic device (e.g., the electronic device 101 of FIG. 5) including the microphone chamber (e.g., the microphone chamber 331 of FIG. 5) may be reduced compared to wind noise g1 of a first reference embodiment of the electronic device that does not include the microphone chamber (e.g., the microphone chamber 331 or the second microphone chamber 391 of FIG. 5). According to an embodiment, in a designated frequency band (e.g., 0 Hz to 4000 Hz), the magnitude of the response to the wind noise g2 of the electronic device including the microphone chamber 331 may be lower than the magnitude of the response to the wind noise g1 of the first reference embodiment. According to an embodiment, wind noise may be interpreted as noise generated due to vibration of the microphone module (e.g., the microphone module 350 of FIG. 5) due to turbulence of wind flowing into the electronic device. According to an embodiment, as wind noise is reduced, the active noise canceling function of the electronic device 101 may be enhanced.

Referring to FIG. 7, graph 402 illustrates that pink noise g3 of the electronic device not including the microphone chamber (e.g., the first microphone chamber 331 of FIG. 5) and pink noise g4 of the electronic device 101 including the first microphone chamber 331 may be substantially the same. For example, even if the electronic device 101 includes the first microphone chamber 331, the performance of the microphone module (e.g., the microphone module 350 of FIG. 5) for obtaining the external sound of the electronic device 101 may be substantially the same as the performance of the electronic device of the reference embodiment that does not include the microphone chamber. The pink noise may be a noise level that is reproduced substantially evenly in the reproduction frequency band. For example, the pink noise may be noise obtained by attenuating and correcting white noise by about 3 decibels dB per octave.

Wind noise and pink noise of the electronic device 101 including the first microphone chamber (e.g., the first microphone chamber 331 of FIG. 5) have been described with reference to FIGS. 6 and 7, but this is selective. For example, wind noise of the electronic device 101 that does not include the first microphone chamber 331 but includes the second microphone chamber 332 and/or the electronic device 101 that includes the first microphone chamber 331 and the second microphone chamber 332 may be lower than wind noise of the electronic device that does not include the microphone chamber (e.g., the first microphone chamber 331 and/or the second microphone chamber 332 of FIG. 5). The pink noise of the electronic device 101 that does not include the first microphone chamber 331 but includes the second microphone chamber 332 and/or the electronic device 101 that includes the first microphone chamber 331 and the second microphone chamber 332 may be substantially the same as the pink noise of the electronic device that does not include the microphone chamber (e.g., the first microphone chamber 331 and/or the second microphone chamber 332 of FIG. 5).

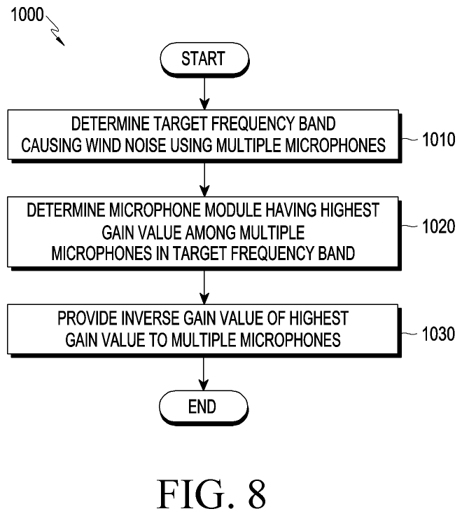

FIG. 8 is a flowchart illustrating operations of an electronic device according to an embodiment of the disclosure.

Referring to FIG. 8, an operation method 1000 of an electronic device 101 may include an operation 1010 of determining a target frequency band causing wind noise using a plurality of microphones, an operation 1020 of determining a microphone module having a highest gain value among the plurality of microphones, and an operation 1030 of providing an inverse gain value of the highest gain value to the plurality of microphones. The plurality of microphones of FIG. 8 may be the first microphone 351, the second microphone 352, and the third microphone 353 of FIG. 5.

According to an embodiment, the processor (e.g., the processor 120 of FIG. 1) and/or the audio module (e.g., the audio module 170 of FIG. 2) may perform the operation 1010 of determining the target frequency band causing wind noise using the plurality of microphones. The target frequency band may be a frequency band having wind noise in common in the plurality of microphones (e.g., the first microphone 351, the second microphone 352, and the third microphone 353). For example, when it is determined that wind noise is generated at 100 Hz to 800 Hz in the first microphone 351, wind noise is generated at 300 Hz to 1 kHz in the second microphone 352, and wind noise is generated at 200 Hz to 900 Hz in the third microphone 353, the processor 120 and/or the audio module 170 may determine 300 Hz to 800 Hz as a target frequency band. A method for determining a frequency band for generating wind noise in one microphone module (e.g., the microphone module 350 of FIG. 5) may be the same as a conventional method for determining wind noise.

According to an embodiment, the processor 120 and/or the audio module 170 may perform the operation 1020 of determining the microphone module having the highest gain value among the plurality of microphone modules 351, 352, and 353 in the target frequency band. For example, the processor 120 and/or the audio module 170 may determine which of the first microphone 351, the second microphone 352, or the third microphone 353 has the highest gain value in the target frequency band. The gain value may be the magnitude dB of the response obtained by the microphone module 350.

According to an embodiment, the processor 120 and/or the audio module 170 may perform the operation 1030 of providing the inverse gain value of the gain value having the highest vocal value to the plurality of microphones. For example, in the electronic device 101 including the three microphones 351, 352, and 353, the processor 120 and/or the audio module 170 may provide the plurality of microphones 351, 352, and 353 with the inverse gain value of the microphone module 350 having the highest gain value in the target frequency band.

For example, the processor 120 and/or the audio module 170 may determine whether the first microphone 351 has the highest gain value. When it is determined that the first microphone 351 has the highest value in the target frequency band, the electronic device 101 may transfer the inverse gain value of the first microphone 351 to the first microphone 351, the second microphone 352, and the third microphone 353. If the first microphone 351 does not have the highest gain value in the target frequency band, the electronic device 101 may determine whether the second microphone 352 has the highest value. When it is determined that the second microphone 352 has the highest value in the target frequency band, the electronic device 101 may transfer the inverse gain value of the second microphone 352 to the first microphone 351, the second microphone 352, and the third microphone 353. If the first microphone 351 and the second microphone 352 do not have the highest gain value in the target frequency band, the electronic device 101 may determine that the third microphone 353 has the highest gain value. When it is determined that the third microphone 353 has the highest value in the target frequency band, the electronic device 101 may transfer the inverse gain value of the third microphone 353 to the first microphone 351, the second microphone 352, and the third microphone 353. The order in which the processor 120 and/or the audio module 170 determines which microphone module 350 among the plurality of microphones 351, 352, and 353 has the highest gain value is selective.

According to an embodiment, the microphone in which the wind noise is generated may be different depending on the direction of the wind transferred to the electronic device 101. The microphone module having the highest gain value may be a microphone module that receives the strongest wind among the plurality of microphones. As the wind noise corresponding to the microphone module having the highest gain value is removed, the wind noise removal efficiency of the electronic device 101 may be increased.

In the disclosure, an operation of determining wind noise using the three microphones 351, 352, and 353 has been described, but this is selective. For example, in an embodiment, the electronic device 101 may determine a target frequency band in which wind noise is generated using some (e.g., two) of the plurality of (e.g., three) microphones. In an embodiment, the electronic device 101 may include two or four or more microphones.

An electronic device wearable on the body may include components related to at least one sound effect. For example, a wearable electronic device including a speaker and a microphone may be worn on a portion close to the user's ear, such as an in-ear earphone (or earset) or a hearing aid.

In the wearable electronic device, the microphone may perform an active noise cancelling (ANC) function. The active noise canceling function may be a function for reducing noise by obtaining a noise-related wave using the microphone module, inverting the phase of the obtained wave, and outputting the phase-inverted wave through the speaker. Noise generated inside or outside the wearable electronic device may be reduced by destructive interference using the active noise canceling function.

However, at least a portion of the microphone module may vibrate and wind noise may be generated due to the wind introduced into the microphone hole of the electronic device in the downsized electronic device. The active noise canceling function may be deteriorated due to wind noise.

According to an embodiment of the disclosure, there may be provided an electronic device capable of reducing wind noise.

The disclosure is not limited to the foregoing embodiments but various modifications or changes may rather be made thereto without departing from the spirit and scope of the disclosure.

According to an embodiment of the disclosure, a wearable electronic device (e.g., the electronic device 101 of FIG. 3) may comprise a housing (e.g., the housing 310 of FIG. 3) including a first surface (e.g., the first surface 310a of FIG. 4B) facing an outside of the wearable electronic device, a second surface (e.g., the second surface 310b of FIG. 4A) opposite to the first surface, and a microphone hole (e.g., the microphone hole 320 of FIG. 4B) formed between the first surface and the second surface, a support (e.g., the support 330 of FIG. 4A) disposed on the second surface and including a microphone chamber (e.g., the microphone chamber 331 of FIG. 4A) at least partially facing the microphone hole, an antenna structure (e.g., the antenna structure 360 of FIG. 4A) positioned on the second surface, a connecting member (e.g., the connecting member 340 of FIG. 5) disposed on the second surface and including a first connection area (e.g., the first connection area 341 of FIG. 5) electrically connected to the antenna structure and a second connection area (e.g., the second connection area 342 of FIG. 5) extending from the first connection area and disposed on the support, and a microphone module (e.g., the microphone module 350 of FIG. 5) disposed on the second surface. The microphone module may obtain an external sound of the wearable electronic device through the microphone hole and the microphone chamber. As the microphone module obtains the sound passing through the microphone hole and the microphone chamber, the wind noise detected in the microphone module may be reduced.

According to an embodiment, the microphone hole may include a first microphone hole (e.g., the first microphone hole 321 of FIG. 4B), a second microphone hole (e.g., the second microphone hole 322 of FIG. 4B), and a third microphone hole (e.g., the third microphone hole 323 of FIG. 4B) spaced apart from each other. The microphone module may include a first microphone (e.g., the first microphone 351 of FIG. 4A) configured to obtain a sound passing through the first microphone hole, a second microphone (e.g., the second microphone 352 of FIG. 4A) configured to obtain a sound passing through the second microphone hole, and a third microphone (e.g., the third microphone 353 of FIG. 4A) configured to obtain a sound passing through the third microphone hole.

According to an embodiment, the wearable electronic device may comprise a touch pad (e.g., the touch pad 370 of FIG. 5) disposed on the second surface.

According to an embodiment, the wearable electronic device may comprise an auxiliary support (e.g., the second support 390 of FIG. 5) disposed on the second surface and including an auxiliary microphone chamber (e.g., the second microphone chamber 391 of FIG. 5) at least partially facing the microphone hole.

According to an embodiment, the wearable electronic device may comprise a touch pad connecting member (e.g., the touch pad connecting member 380 of FIG. 5) disposed on the second surface and including a third connection area (e.g., third connection area 381 of FIG. 5) electrically connected to the touch pad and a fourth connection area (e.g., fourth connection area 382 of FIG. 5) extending from the third connection area and disposed on the auxiliary support. As the microphone module obtains the sound passing through the second microphone hole and the auxiliary microphone chamber, the wind noise may be reduced.

According to an embodiment, the wearable electronic device may further comprise a circuit board positioned in the housing to accommodate an audio module (e.g., the audio module 170 of FIG. 2). The second connection area may include a connector connected to the circuit board.

According to an embodiment, a second width (e.g., the second width w2 of FIG. 5) of the microphone chamber may be larger than a first width (e.g., the first width w1 of FIG. 5) of the microphone hole. Due to the structure of the microphone chamber, wind noise may be reduced.

According to an embodiment, the support may extend from the second surface and be formed as a single piece with the housing.

According to an embodiment, the connecting member may include at least one of a flexible printed circuit board or a cable.

According to an embodiment, the housing may include a first wearing part (e.g., the first wearing part 311 of FIG. 3), a second wearing part (e.g., the second wearing part 312 of FIG. 3) spaced apart from the first wearing part, and a band part (e.g., the band part 313 of FIG. 3) connecting the first wearing part and the second wearing part.

According to an embodiment, the microphone hole may be formed in at least one of the first case or the second case.

According to an embodiment, the first surface and the second surface may be formed to be substantially flat. As the first and second surfaces are formed to be substantially flat, the wind transferred to the plurality of microphones may be substantially uniform. As uniform winds are provided to the housing, the processor may determine a target frequency band commonly causing wind noise in the plurality of microphones.

According to an embodiment, the electronic device may further comprise a processor (e.g., the processor 120 of FIG. 1) disposed in the housing. The microphone module may include a plurality of microphones (e.g., the first microphone 351, the second microphone 352, and the third microphone 353 of FIG. 4A), and the processor may be configured to determine a target frequency band commonly causing wind noise in the plurality of microphones.

According to an embodiment, the processor may be configured to determine a microphone module having a highest gain value among the plurality of microphones in the target frequency band. The processor may be configured to an inverse gain value of the highest gain value to the plurality of microphones.

According to an embodiment, the electronic device may further comprise a sound absorbing member positioned in the microphone chamber. Due to the sound absorbing member, wind noise may be reduced.

According to an embodiment of the disclosure, an electronic device (e.g., the electronic device 101 of FIG. 3) may comprise a housing (e.g., the housing 310 of FIG. 3) including a wearing part (e.g., the first wearing part 311 and the second wearing part 312 of FIG. 3), a microphone hole (e.g., the microphone hole 320 of FIG. 3) including a first microphone hole (e.g., the first microphone hole 321 of FIG. 3) and a second microphone hole (e.g., the second microphone hole 322 of FIG. 3) formed in the wearing part, an antenna structure (e.g., the antenna structure 360 of FIG. 4A) positioned on an inner surface of the wearing part, a touch pad (e.g., the touch pad 370 of FIG. 5) positioned on the inner surface of the wearing part, a support positioned on the inner surface of the wearing part, and including a first support (e.g., the first support 330 of FIG. 5) including a first microphone chamber (e.g., the microphone chamber 331 of FIG. 5) and a second support (e.g., the second support 390 of FIG. 5) including a second microphone chamber (e.g., the second microphone chamber 391 of FIG. 5), a connecting member including a first connecting member (e.g., connecting member 340 of FIG. 5) connected to the antenna structure and at least partially disposed on the first support and a second connecting member (e.g., touch pad connecting member 380 of FIG. 5) connected to the touch pad and at least partially disposed on the second support, and a microphone module (e.g., the microphone module 350 of FIG. 5) including a first microphone (e.g., the first microphone 351 of FIG. 5) configured to obtain a sound passing through the first microphone hole and the first microphone chamber and a second microphone (e.g., the second microphone 352 of FIG. 5) configured to obtain a sound passing through the second microphone hole and the second microphone chamber.

According to an embodiment, the microphone module may include a third microphone (e.g., the third microphone 353 of FIG. 4A) spaced apart from the first microphone or the second microphone. The electronic device may further comprise a processor (e.g., the processor 120 of FIG. 1) disposed in the housing. The processor may be configured to determine a target frequency band commonly causing wind noise in the first microphone, the second microphone, and the third microphone.

According to an embodiment, the processor may be configured to determine a microphone having a highest gain value among the first microphone, the second microphone, and the third microphone in the target frequency band. The processor may be configured to provide an inverse gain value of the highest gain value to the first microphone, the second microphone, and the third microphone.

According to an embodiment, the wearing part may include a first wearing part (e.g., the first wearing part 311 of FIG. 3) and a second wearing part (e.g., the second wearing part 312 of FIG. 3) spaced apart from the first wearing part. The housing may include a band part (e.g., the band part 313 of FIG. 3) connecting the first wearing part and the second wearing part.

According to an embodiment of the disclosure, an operation method (e.g., the operation method 1000 of the electronic device of FIG. 8) of an electronic device may comprise determining (e.g., operation 1010 of FIG. 8) a target frequency band causing wind noise commonly in a plurality of microphones, determining (e.g., operation 1020 of FIG. 8) a microphone module having a highest gain value among the plurality of microphones in the target frequency band, and providing (e.g., operation 1030 of FIG. 8) an inverse gain value of the highest gain value to the plurality of microphones.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes, in form and details may be made therein without departing from the spirit and scope of the disclosure as defined by the appended claims and their equivalents.

What is claimed is:

1. A wearable electronic device comprising:
a housing including a first surface facing an outside of the wearable electronic device, a second surface opposite to the first surface, and a microphone hole formed between the first surface and the second surface;
a support disposed on the second surface and including a microphone chamber at least partially facing the microphone hole;
an antenna structure positioned on the second surface;
a connecting member disposed on the second surface and including a first connection area electrically connected to the antenna structure and a second connection area extending from the first connection area and disposed on the support; and
a microphone disposed on the second surface and configured to obtain an external sound of the wearable electronic device through the microphone hole and the microphone chamber.

2. The wearable electronic device of claim 1,
wherein the microphone hole includes a first microphone hole, a second microphone hole, and a third microphone hole spaced apart from each other, and
wherein the microphone includes a first microphone configured to obtain sound passing through the first microphone hole, a second microphone configured to obtain sound passing through the second microphone hole, and a third microphone configured to obtain sound passing through the third microphone hole.

3. The wearable electronic device of claim 1, further comprising:
a touch pad disposed on the second surface.

4. The wearable electronic device of claim 3, further comprising:
an auxiliary support disposed on the second surface and including an auxiliary microphone chamber at least partially facing the microphone hole; and
a touch pad connecting member disposed on the second surface and including a third connection area electrically connected to the touch pad and a fourth connection area extending from the third connection area and disposed on the auxiliary support.

5. The wearable electronic device of claim 4,
wherein the microphone hole includes a first microphone hole and a second microphone hole spaced apart from the first microphone hole, and
wherein the microphone includes a first microphone configured to obtain sound passing through the first microphone hole and the microphone chamber and a second microphone configured to obtain sound passing through the second microphone hole and the auxiliary microphone chamber.

6. The wearable electronic device of claim 1, further comprising:
a circuit board positioned in the housing to accommodate an audio,
wherein the second connection area includes a connector connected to the circuit board.

7. The wearable electronic device of claim 1, wherein a second width of the microphone chamber is larger than a first width of the microphone hole.

8. The wearable electronic device of claim 1, wherein the support extends from the second surface and is formed as a single piece with the housing.

9. The wearable electronic device of claim 1, wherein the housing further includes a first wearing part, a second wearing part spaced apart from the first wearing part, and a band part connecting the first wearing part and the second wearing part.

10. The wearable electronic device of claim 9, wherein the microphone hole is formed in at least one of the first wearing part or the second wearing part.

11. The wearable electronic device of claim 1, further comprising:
a processor disposed in the housing,
wherein the microphone includes a plurality of microphones, and
wherein the processor is configured to determine a target frequency band commonly causing wind noise in the plurality of microphones.

12. The wearable electronic device of claim 1, further comprising:
a sound absorbing member positioned in the microphone chamber.

13. An electronic device comprising:
a housing including a wearing part;
a microphone hole including a first microphone hole and a second microphone hole formed in the wearing part;
an antenna structure positioned on an inner surface of the wearing part;
a touch pad positioned on the inner surface of the wearing part;
a support positioned on the inner surface of the wearing part and including a first support and a second support, the first support including a first microphone chamber and the second support including a second microphone chamber;
a connecting member including a first connecting member connected to the antenna structure and at least partially disposed on the first support and a second connecting member connected to the touch pad and at least partially disposed on the second support; and
a microphone including:
a first microphone configured to obtain sound passing through the first microphone hole and the first microphone chamber, and
a second microphone configured to obtain sound passing through the second microphone hole and the second microphone chamber.

14. The electronic device of claim 13,
wherein the microphone further includes a third microphone spaced apart from the first microphone or the second microphone,
wherein the electronic device further comprises:
a processor disposed in the housing, and
wherein the processor is configured to determine a target frequency band commonly causing wind noise in the first microphone, the second microphone, and the third microphone.

15. The electronic device of claim 13,
wherein the wearing part includes a first wearing part and a second wearing part spaced apart from the first wearing part, and
wherein the housing further includes a band part connecting the first wearing part and the second wearing part.

16. The electronic device of claim 13,
wherein the microphone hole further includes a third microphone hole,
wherein the first microphone hole, the second microphone hole, and the third microphone hole are spaced apart from each other, and
wherein the microphone further includes a third microphone configured to obtain sound passing through the third microphone hole.

17. The electronic device of claim 13, wherein a second width of the first microphone chamber is larger than a first width of the first microphone hole.

18. The electronic device of claim 13, wherein the support extends from the inner surface and is formed as a single piece with the housing.

19. The electronic device of claim 13, further comprising:
a sound absorbing member positioned in the first microphone chamber.

20. The electronic device of claim 13, further comprising:
an auxiliary support disposed on the inner surface and including an auxiliary microphone chamber at least partially facing the second microphone hole; and
a touch pad connecting member disposed on the inner surface and including a first connection area electrically connected to the touch pad and a second connection area extending from the first connection area and disposed on the auxiliary support,
wherein the microphone further includes a first microphone configured to obtain sound passing through the first microphone hole and the first microphone chamber and a second microphone configured to obtain sound passing through the second microphone hole and the auxiliary microphone chamber.
